(19) United States
(12) Patent Application Publication
(10) Pub. No.: US 2022/0380642 A1
(43) Pub. Date: Dec. 1, 2022

(54) Compressible UV-activatable or thermally activatable (semi-) structural adhesive film that changes color after activation and after curing

(71) Applicant: LOHMANN GMBH & CO. KG, Neuwied (DE)

(72) Inventors: Ruben FRIEDLAND, Andernach (DE); Victoria RITTER, Mendig (DE); Johannes STAHL, Koblenz (DE)

(73) Assignee: LOHMANN GMBH & CO. KG, Neuwied (DE)

(21) Appl. No.: 17/624,903

(22) PCT Filed: Jul. 3, 2020
(86) PCT No.: PCT/EP2020/068910

§ 371 Date: Jan. 5, 2022

(30) Foreign Application Priority Data
Jul. 5, 2019 (DE) 10 2019 004 662.5

(51) Int. Cl. C09J 163/00; C09J 7/10; C09J 7/35; C09J 11/06; C08K 5/00

(52) U.S. Cl. CPC C09J 163/00; C09J 7/10; C09J 7/35; C09J 11/06; C08K 5/0041; C09J 2301/408; C09J 2301/304; C09J 2301/416

(57) ABSTRACT

An adhesive film that can be wound and punched, comprising an epoxy-based adhesive compound that can be activated by UV-radiation or thermally and an expandable filler admixed to the adhesive compound to produce an adhesive film that is compressible when not yet cured.

### CROSS REFERENCE TO RELATED APPLICATIONS

This application is a national stage U.S. patent application of International Application No. PCT/EP2020/068910, filed on Jul. 3, 2020, and claims foreign priority to German Patent Application No. DE 10 2019 004 662., filed on Jul. 5, 2019, the entirety of each of which is incorporated herein by reference.

### TECHNICAL FIELD

The present disclosure relates to an adhesive film that can be wound and punched that can be activated and cured thermally or through ultraviolet radiation (UV) for structural adhesive bonds with color change following activation, which is compressible in its non-activated state. In this sense, wherever UV-activation is referenced in the following, thermal activation is inferred as a possible alternative, as well.

### DESCRIPTION OF THE RELATED TECHNOLOGY

Often, the base of UV-curing adhesives consists in acrylate monomers or oligomers that cure in a UV-induced radical chain reaction.

UV-curing epoxy adhesives in turn are cured by a cationic photo initiator. In cationic UV-curing, a ring opening occurs at the oxirane and/or oxetane (epoxy resins and vinyl ether). This is achieved by way of photolysis e.g. of diaryliodononium salts, which is based on the generation of strong proton acids. The acid proton opens the epoxy ring and sets off the chain growth and thus curing.

In contrast to radical UV-curing of acrylates, this results in reduced shrinking and good adhesion properties in respect of a large number of substrates. Yet another advantage of cationic curing consists in its insensitivity towards oxygen, allowing for high curing speeds under regular air conditions. Humidity and alkaline conditions, in turn, tend to be of more influence than in radical UV-curing.

In cationic initiation, it is possible under certain circumstances to delay chain formation to such an extent that it ultimately may occur in the dark without further exposure to radiation. Chain formation may potentially also be substantially delayed so that it is only reactivated or re-accelerated by heat treatment. “Trigger radiation”, i.e. a brief kick-start by radiation is sufficient to start curing. Further curing then occurs in the optional subsequent dark reaction—outside of the UV light. Under these circumstances it is even possible that a certain “open time” is created, i.e. first the open adhesive layer is irradiated and afterwards there is time to perform the joining with the second substrate without impairment of the ultimate bonding properties. This approach would then allow for bonding substrates that are not UV-transparent.

UV-activatable adhesive tapes are known in the art: WO 2017/174303 A1 relates to a radiation-activatable pressure-sensitive adhesive tape consisting of a radiation-activatable polymerisable composition consisting of: 5 to 60 parts by weight of at least one film former component; 40 to 95 parts by weight of at least one epoxy component; 0.1 to 10 parts by weight of at least one photo-initiator, and optionally 0.1 to 200 parts by weight of at least one additive, based in each case on the radiation-activatable polymerisable composition, where the parts by weight of said individual components add up to 100.

WO 2018/153985 A1 provides an adhesive film that can be wound and punched including an epoxy-based adhesive compound that can be activated by UV-radiation, the adhesive compound comprising: 2-40 percent by weight of film former; 10-70 percent by weight of aromatic epoxy resins; cyclo-aliphatic epoxy resins, the cyclo-aliphatic epoxy resins not exceeding 35 percent by weight; 0.5-7 percent by weight of cationic initiators; 0-50 percent by weight of epoxydised polyether compounds; and 0-20 percent by weight of polyol, with the shares adding up to 100 percent.

In industrial contexts in general, requirements for adhesive bonds are ever increasing, for example in terms of breaking strength, temperature resilience, changing climate resilience, humidity heat resilience, etc. This is due to the fact that adhesive tapes are used increasingly in automotive manufacturing, e.g. for weight reasons or also because with using such tapes it is not necessarily required to create point-shaped bonds, instead even distribution of the bonding strength is achieved across an adhesive seam, and last but not least also because the join partners are not damaged as is the case with certain other joining procedures such as for example screwed links or riveting.

In many processes, for example in the automotive industry, the manufacturers of adhesive compounds/adhesive tapes are required to ensure and prove the activation or curing thereof. Accordingly, there are high requirements associated with process control in the processing of these adhesive compounds.

UV-activatable liquid adhesive compounds able to indicate activation by changing color may help overcome this issue. EP 3 105 276 B1 for example describes an irreversible color change of an epoxy adhesive from blue to yellow.

Also known in the art is the bathochromic effect, also referred to as red shift, which describes a color shift. Here, the absorption spectrum is shifted to the long-wave lower energy range of the electromagnetic spectrum. (cf. K. Schwetlick: Organikum. 15th edition, VEB Deutscher Verlag der Wissenschaften, Berlin 1976, p. 513 et seq.)

In turn, this color shift can be effected also by the halochromic effect (“salt color”), which describes the color change of a substance depending on the charge state of its molecules.

One example thereof is litmus, which changes its color from red (acidic) to blue (alkaline) depending on the pH value of an aqueous solution.

Using the known systems it is currently only possible to indicate activation in liquid adhesives. Accordingly, there is a need for similar process control options to cover structural adhesive films, as well. Moreover, there is need to determine not only the moment of activation for such process control but also the moment when sufficient curing has been achieved, as described in patent application PCT/EP2018/084413, which has not yet been published.

Moreover, none of the above adhesive films allow for tolerance compensation of the join partners to be joined to the same extent as it is possible with the liquid adhesives. However, given that real components will always come with tolerances caused by the manufacturing process, this constitutes a crucial characteristic.

WO 2014/071334 A1 relates to an adhesive film based on epoxy resin, comprising core-shell rubber particles and thermally expandable micro-particles that expand during curing subject to the influence of the curing temperature. This is associated with the disadvantage that the join partners are not optimally wetted prior to curing due to the join part tolerances and that this only occurs during the expansion stage during curing. Under these circumstances, however, adhesion to the join partner is no longer guaranteed as a consequence of the progressive cross-linking, so that often adhesion to the second join partner is compromised. Moreover, introducing heat during the curing process is an unequivocal requirement.

### ILLUSTRATION OF THE DISCLOSURE

The terminology used in the descriptions below is to be understood as follows:

“Adhesive film” hereinafter relates to any type of spatial adhesive system, i.e. not only adhesive tapes in the stricter sense of the word but also adhesive films, adhesive strips, adhesive plates or adhesive punched parts.

“Pressure-sensitive adhesive” refers to adhesive bonds where the two join partners are bonded together by way of an intermediary adhesive layer and subject to pressure. The bond is reversible in that it can be released again without damaging the two join partners, because the adhesive seam is the weakest link in the adhesive bond.

“Structural” or “semi-structural” adhesive bonds, respectively, are such bonds where the join partners are bonded in such a manner that, in the event of separation, the bond is not necessarily released at the adhesive seam, but that under certain circumstances also one of the join partners may constitute the weakest link in the bond, which is then damaged due to the separation. This means that structural and semi-structural adhesive bonds possess high strength levels. The strength values measured in the quasi-static tensile shear test according to DIN 1465, exceed 6 MPa for structural compounds, for semi-structural compounds they usually amount to >2 MPa. Typical aspirational values for structural adhesive bonds of epoxy adhesives are between 10 to 20 MPa.

“Radiation curing” refers to a process where, using high-energy rays, reactive materials are conveyed from a low-molecular to a high-molecular state.

In the case in hand, UV-radiation is understood to be “UVA” or “UVC” light. UVA-radiation is in a wavelength range of ca. 380 to 315 nanometres (nm), UVC-radiation is in a wavelength range of ca. 280 to 100 nm. Generally, both constitute electromagnetic radiation at wavelengths shorter than visible light. For UV-A light, the energy input is ca. 3.26 to 3.95 electron volts (eV), for UV-C light, the energy input is ca. 4.43 to 12.40 eV.

“Activation” means initiating a curing process by irradiation with UV-light, i.e. the photo initiators contained in the adhesive are activated by light irradiation and trigger the curing process of the adhesive by initiating the formation of polymer chains. Customarily, UV-curing adhesives are irradiated after the join partners have been joined. For this, substrates are required that are sufficiently permeable for the UV-radiation applied. The adhesion seam is irradiated until the curing has progressed sufficiently, i.e. sufficient strength has been obtained. Consequently, only UV-permeable substrates can be activated and glued together that way. Final adhesive compound strength is only achieved upon completion of the curing process.

The “open time” is the time between the application of the adhesive and the bonding. During the open time, for example, a liquid melt adhesive will spread across the surfaces to be bonded, thus providing for the requisite adhesion. Given that the viscosity of an adhesive generally increases after application, the open time of adhesives is limited in terms of time.

The “curing time” is the period between the joining of the join partners until the final strength of the bond has been reached.

The “dark reaction” refers to the fact that a curing reaction is initiated (triggered) by short-term irradiation of the adhesive with UV-light, thus effecting complete curing without additional irradiation.

“Thermal activation” refers to initiating the curing process by applying increased temperature, i.e. a temperature of at least 140° C. in the case in hand.

“Superacid” means the following: In cationic UV-curing, a ring opening occurs at the oxirane and/or oxetane (epoxy resins and vinyl ether). This is achieved by way of photolysis e.g. of diaryliodononium salts, which effect the generation of strong proton acids, also referred to as superacids. The acid proton opens the epoxy ring and sets off the chain growth and thus curing.

The term “compressible” hereinafter refers to a film adhesive or an adhesive film that can be subjected to pressure deformation prior to UV- or thermal activation and that returns to its original thickness after pressure relief.

An object of the present disclosure to provide an adhesive film that can be wound and punched, that is compressible when it is not yet cured to compensate for join partner tolerances and which exhibits a color change following activation through UV-radiation or temperature to indicate activation, and a repeated color change after curing, thus allowing for process control, as well as a corresponding method for manufacturing such a film.

Accordingly, an adhesive film that can be wound and punched is described, comprising an epoxy-based adhesive compound activatable thermally or by UV-radiation. According to the disclosure, the adhesive compound comprises both an admixed dye or an admixed pigment for generating a first color-change following activation of the adhesive compound and a second color change following curing of the adhesive compound and a filler agent admixed to the adhesive compound for generating an adhesive film that is compressible when it is not yet cured.

This allows for in-process control that, apart from identifying the start of activation of the adhesive compound, additionally color-indicates the progress of the cross-linking reaction of the adhesive compound so that the curing status can be rendered visible. In this context, the prior art offers nothing in respect of a UV-activatable adhesive film based on an epoxy resin adhesive compound that is compressible when not yet cured, in which no further initiator is required as radical starter for activation except for the cationic photo initiator, and that exhibits color change due to the addition of a dye or pigment after activation, which may thus serve as process control. Open time, shelf life and curing speed of the adhesive compounds use are not affected by the addition of such dyes or pigments.

The adhesive film in hand allows for complete process control of the UV-activation by means of color change during the joining process of available applications of the UV-activatable adhesive compounds. For example, by adding the dye Sudan blue, an adhesive dyed blue can be produced that color changes to pink-violet following UV-activation.

After a period of ca. 24 hours, the color hue of the adhesive once again shifts back to blue, which is due to the decomposition or the depletion reaction of the acid contained in the adhesive. Thus, the user has control over the activation and reaction state of the adhesive film, respectively.

The additional use of corresponding additives resulting in expansion during the production of the adhesive film creates an adhesive film that is compressible prior to the UV- or thermal activation.

Thus, the finished adhesive film can be applied on components with tolerances caused by the manufacturing process prior to curing and compensates for these tolerances by its compressing ability in analogy to a foam. Therefore, wetting of real components prior to curing across the entire surface can be ensured.

The processing and coating of the adhesive compound can be carried out using a solvent or hotmelt process. Also the so-called syrup technology can be used for processing and coating, where the film forming component is produced from monomers or oligomers not until during the coating process.

The adhesive film is pressure-sensitive adhesive in its non-activated state and can thus be handled just like any “regular” pressure-sensitive adhesive tape, i.e. it can be applied subject to mild adhesion and, if necessary, can also be repositioned. Punched parts can be manufactured from the adhesive tape that can be activated by UV-light prior to application on the respective parts to be bonded in order to generate a (semi-)structural compound after cross-linking.

Typically, also liners (release liners) are a component of adhesive tapes. Here, as a general rule, all ubiquitously known types of release liners can be used.

The curing of the adhesive films and punched parts is finally activated using UV-light, for example, UVA- or UVC-light. Only then the join partners are finally and structurally joined. Given that the curing reaction takes place in several steps, also after activation a certain period remains during which the join partners can be finally aligned and joined, additional activation is no longer necessary after curing has been triggered by UV-light.

The duration of the dark reaction strongly depends on different factors such as for example the epoxy resin component used (cyclo-aliphatic or aromatic epoxy resin), the chain length, the initiator type, the radiation time, the radiation dosage (UV-wavelength) or also the temperature. The curing time after radiation may amount to between 10 seconds and 60 minutes depending on the aforementioned factors and their interaction.

In yet another embodiment, the adhesive compound comprises:
a. 2-50 percent by weight of film formers,
b. 10-70 percent by weight of aromatic epoxy resins,
c. 0.5-7 percent by weight of a cationic initiator,
d. 0.1 to 70 percent by weight of an additive responsible for expanding the pre-polymer (=expandable filler agent),
d. 0.001-0.2 percent by weight of dye or pigment,
e. cyclo-aliphatic epoxy resins, the cyclo-aliphatic epoxy resins not exceeding 35 percent by weight,
f. 0-50 percent by weight of epoxy-enhanced polyether compounds, and
g. 0-20 percent by weight of polyol,
   the shares adding up to 100 percent.

The adhesive compound has an open time of 10 seconds to 60 minutes after UV-activation during which the film is tacky before it has cured completely and reached its final strength.

In yet another application, the additive responsible for expanding has an activation temperature between 30° C. and 150° C. and a maximum degree of expansion between 40° C. and 150° C., for example, between 60° C. and 130° C. This allows for expansion during the drying process of the adhesive film that can be adjusted precisely. Thus it is possible to produce defined layer thicknesses and degrees of compression that accommodate the respective requirements of specific applications. Fillers requiring higher activation energy and temperature, respectively, have to be tempered additionally in a separate step, which is not favorable from an energy consumption point of view.

In an embodiment, the not yet cured adhesive film exhibits compression between 5 and 80% depending on filler agent concentration and expansion. This compression allows for compensating join partner tolerances and thus to achieve complete wetting. However, the strength values of the adhesive film decrease as a factor of compressibility so that in the case of minor join partner tolerances a low filler agent concentration and thus compression is more effective. If, however, during subsequent application, stress is caused by temperature changes, high compressibility and thus malleability perpendicular to the major surface is advantageous to compensate for any tension caused by different thermal expansion coefficients.

In a further development, the adhesive film is provided as a UV-activatable compressible transfer adhesive tape without backing.

In a further development, the adhesive film comprises a UV-transparent or a UV-intransparent backing. By equipping the adhesive film with a UV-transparent or UV-intransparent backing, the adhesive film can be adjusted to accommodate the application and process requirements of a particular client. It is for example possible to completely separate the cross-linking of the two adhesive layers both spatially and chronologically using a UV-intransparent backing.

In a embodiment, the adhesive film comprises at least one UV-activatable or thermally activatable adhesive compound. Due to the fact that the adhesive film includes at least one thermally activatable adhesive compound, higher strength values and chemical resistance values can be achieved.

In an embodiment, 0.001 to 0.2 percent by weight, for example, 0.01 to 0.07 percent by weight or 0.015 to 0.04 percent by weight of the dye or the pigment, respectively, are admixed to the adhesive compound. In concentrations less than 0.001 percent by weight the coloration of the adhesive compound is no longer visually detectable to a sufficient extent of process liability, in concentrations higher than 0.2 percent by weight, the dye or the pigment and its/their amine groups or nitrogen compounds create an alkaline milieu, preventing a reaction of the superacid with the epoxy groups and an azo group.

In a further development the dye or the pigment is an azo dye or an azo pigment. In particular, dyes or pigments are advantageous that exhibit color change subject to acid exposure. Examples thereof are methyl red, methyl orange, Congo red and alizarin yellow R.

Dyes or pigments of the azo group are causal for the color change. They change color due to protonation when certain pH values are no longer reached. Below, this is illustrated for the azo dye methyl red in an exemplary fashion, which occurs in red and in its protonated form in acidic media (see the right structure indicated below) and in yellow and in its deprotonated form in alkaline media (see left structure indicated below).

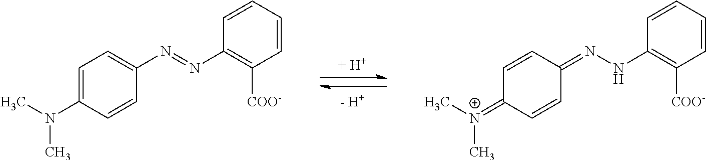

Subject to increased atmospheric humidity, the color change is less pronounced, because the resulting acid particles can bond to the OH ions of the water and thus to a lesser extent to the dye or the pigment, respectively. Simultaneously, in these cases the completely cured adhesive tape is less densely cross-linked, which manifests itself in decreased strength values in tensile testing and associated increased elongation at break values.

In a further development, the adhesive film comprises different adhesive compound systems, at least one of which is a UV-activatable system.

In an embodiment, the adhesive film that can be wound and punched is suitable in particular for the structural bonding of metals, glass, ceramics, fibre-enhanced plastics (FEP), carbon fibre plastic (CFP) and other high-energy surfaces.

In a further embodiment, the adhesive film that can be wound and punched exhibits adhesion strength rates between 6 and 20 MPA depending on the formulation details, radiation dosage and adhesive substrates.

In another embodiment, the adhesive film that can be wound and punched is suitable for (semi-)structural bonding of plastics and further low-energy surfaces.

### DETAILED DESCRIPTION OF EMBODIMENTS

Described hereinafter is the manufacture of an adhesive film and its UV-activation. Samples were produced using the manufacturing method described herein. The samples were subjected to various examinations to test their characteristics. The results of the tests are described in detail below.

Adhesive compound 1 comprises the following composition:
a. 2-50 percent by weight of film formers,
b. 10-70 percent by weight of aromatic epoxy resins,
c. 0.5-7 percent by weight of a cationic initiator,
d. 0.001-0.2 percent by weight of dye or pigment,
e. cyclo-aliphatic epoxy resins, the cyclo-aliphatic epoxy resins not exceeding 35 percent by weight,
f. 0.1 to 70 percent by weight of at least one additive responsible for the expansion during drying (expandable additive),
g. 0-50 percent by weight of epoxy-enhanced polyether compounds, and
h. 0-20 percent by weight of polyol,
   the shares adding up to 100 percent.

Following UV-activation, the adhesive compound has an open time of 10 seconds to 60 minutes, during which the film is tacky.

The dye and the pigment, respectively, can be an azo dye or an azo pigment and in particular such azo substances that exhibit color change after exposure to acid. The table below lists a few exemplary azo dyes:

TABLE 1

| | |
|---|---|
| Fett-Blau B 01 | Blue anthraquinone dye by the company Clariant |
| [Oil Blue B 01]. | Produkte (Deutschland) GmbH. |
| Orasol Yellow 081. | Yellow metal complex dye by the company BASF |
| | Colors & Effects GmbH. |
| Heliogen Green | Green halogenated copper phthalocyanine pigment |
| L 8730. | by the company BASF Colors & Effects GmbH. |

Color change following UV-activation or thermal activation occurs at additive volumes between 0.001 and 0.2 percent by weight of the dye and the pigment, respectively. In concentrations less than 0.001 percent by weight, the coloration of the adhesive compound is no longer visually detects able to ensure a sufficient extent of process reliability, in concentrations higher than 0.2 percent by weight the dye or the pigment and their amine groups or nitrogen compounds create an alkaline milieu, preventing a reaction of the superacid with the epoxy groups and an azo group.

The experiments indicated a range of 0.01 to 0.07 percent by weight, for example, 0.015 to 0.04 percent by weight of the dye and the pigment, respectively.

Subject to increased atmospheric humidity, the color change is less pronounced, because the resulting acid particles can bond to the OH ions of the water and thus to a lesser extent to the dye or the pigment, respectively. Simultaneously, in these cases the completely cured adhesive tape is less densely cross-linked, which manifests itself in decreased strength values in tensile testing and associated increased elongation at break values.

The two filler agents responsible for expansion are thermo-expandable micro spheres, which are produced by encapsulating liquid low evaporation hydrocarbons in thermoplastic polymer sleeves. Those typically exhibit particle sizes of 5 μm to 50 μm and their activation temperatures range from 30° C. to 300° C.

It derives from experiments that the temperature range for a maximum degree of expansion is between 40° C. and 150° C., for example, between 60° C. and 130° C. This results in an adhesive film that is compressible prior to final curing.

The adhesive compound containing solvents is applied on a silicon-enhanced polyester film (thickness: 50 μm) using a blade. Then it first is dried at room temperature for 10 minutes and then at 80° C. in a convection oven for 10 minutes.

The applied amount is set such that after drying (removal of the solvent mixture) a pressure-sensitive adhesive (tacky) film with a thickness of 150 μm is obtained.

No protective measures against UV-light are necessary regarding the handling of the raw materials, the adhesive and the coating. It is sufficient to work under regular laboratory conditions away from the UV-lamp. No further shielding is required.

The UV-source required for UV-activating the UV-activatable adhesive compound may for example be UV-C light from a discharging lamp or UV-A light from a UV-A-LED source.

Tests with a UV-C lamp are carried out in a UV-lab device by the company Beltron with a conveyor belt and a UV-C radiator with a radiation maximum at 256 nm. The conveyor belt is operated at 2 m/min. The radiation dosage in the UV-C range, measured using a UV Power Puck II by the company EIT Instrument Market Group, amounts to 197 mJ/cm².

In the alternative, regardless of a substantially higher wavelength, the adhesive compounds can also be activated with a UV-LED device. Similar irradiation times as in the UV-C device are feasible, and the results regarding open time and adhesion strength are in the same range.

Tests with a UV-LED device are carried out with a LED spot lamp 100 by the company Hönle, comprising a UV-LED (wavelength 365 nm) and a radiation chamber. The samples are irradiated in the radiation chamber for 15 seconds. The radiation dosage, measured using a UV Power Puck II by the company EIT Instrument Market Group, amounts to 5000 mJ/cm².

Below, we specified the terms open time, time until handling strength and curing time in further detail as they are to be understood in the context in hand.

Open time is considered the maximum feasible duration between the removal from the radiation belt (UV-C) or removal from the radiation chamber (UV-A), respectively, and the joining with the second substrate. During this period, the join parts can be joined. The open time is defined such that the adhesive layer is still pressure-sensitive adhesive (tacky). It is determined by finger-checking the tackiness of the surface of the adhesive films after radiation. Directly after radiation, the adhesive film is still tacky. After a certain time, the degree of tangible tack decreases and diminishes further until eventually the surface is non-tacky. The open time is determined as per the point in time when tack tangibly decreases so conceivably that afterwards no tack remains.

It turns out that as long as the surfaces are still tacky, joining is possible and that the subsequent curing results in a homogeneous adhesive bond. The curing process proceeds more and more to the same extent as the surfaces gradually lose tack so that ultimately no joining is possible any longer. This is reflected in the significantly reduced strength values determined based on the quasi-static tensile shear strength.

Additionally, by way of the color change, which is novel for such adhesive films, activation can be detected, and the additional color change over time following activation allows for a determination of the open time. The adhesive films are joined directly after UV-activation.

The curing time is the period between the joining of the adhesive partners and the final strength of the bond. All sample formulations are fully cured after a maximum of 24 hours. Therefore, for the most part the waiting time was 24 hours before the quasi-static tensile shear strength was measured. When a value in excess of 6 MPa is achieved, structural strength or structural bonding is obtained. Due to the added dye and the added pigment, respectively, the color hue allows for the determination whether the formulation has cured completely. The adhesive compound has fully reacted in terms of its cross-linking status in relation to the temperature provided during the cross-linking.

Sufficient open time is desired for application. Rapid achievement of handling strength is advantageous in case the bond has to withstand a first load soon after joining (e.g. during transport of the parts) or in order to forego prolonged fixing of the parts, respectively. For full curing, however, 24 hours is sufficient because according to experience only after that amount of time the bond is subjected to its final load (permanent load or shock loads).

Open time and curing time are consequences of the reaction speed of the curing reaction. This reaction starts with the UV-activation and ends with the complete curing of the adhesive film. Curing is complete once the final strength of the adhesive bond has been achieved. During the open time and curing time, different phases with different reaction speeds may take place, there may be delays and accelerations, resulting in a specific overall open time and curing time. The open time and the curing time can be controlled via the formulation, the radiation type and intensity and duration as well as thermal management (temperatures) during the gluing process.

The time until handling strength means the period that elapses after the joining step until the strength of the bond is so high that glued parts can already be transported and processed further. Experience has shown that handling strength is achieved once the quasi-static shear strength has reached 2 MPa. This strength allows for sufficient leeway for the loads that occur during an industrial manufacturing process.

Table 2 lists the raw materials used:

TABLE 2

| | |
|---|---|
| Phenoxy Resin | Solid phenoxy resin by the company Gabriel |
| PKHH-25-B | Chemie GmbH |
| D.E.R. 331 | Epoxy resin based on bisphenol-A-diglycidylether |
| | with an epoxy equivalent weight of 182-192 |
| | g/eq by the company DOW Chemical Co. |
| D.E.R. 736 | Epoxy resin based on propylene glycol |
| | diglycidylether with an epoxy equivalent weight of |
| | 175-205 g/eq by the company DOW Chemical Co. |
| Struktol Polycavit | Epoxy functional polyester polyether co-polymer |
| 3550 | with an epoxy equivalent weight of 1800 g/eq by |
| | the company Firma Schill + Seilacher |
| | “Struktol”. |
| Araldite DY 3601 | Di-functional, reactive thinning agent for epoxy |
| | resins by the company HUTSMAN HOLLAND BV. |
| Omnicat 432 | Hexa-fluor-phosphate based photo-initiator by the |
| | company IGM RESINS. |
| Dynasylan | Ethoxy silane based gluing agent by the company |
| GLYEO | EVONIK Industries. |
| Fett-Blau B 01 | Blue anthraquinone dye by the company Clariant |
| [Oil Blue B 01]. | Produkte (Deutschland) GmbH. |
| Microsphere F-35D | Thermally expandable filler by the company |
| Microsphere F-36D | MATSUMOTO YUSHI-SEIYAKU Co., Ltd. |
| Expancel 920 | Thermally expandable filler by the company |
| DU 40 | Nouryon Akzo Nobel Chemicals GmbH |

Test Methods

a) Color Change

The color change is observed visually and documented photographically. The process is documented prior to activation by temperature or UV-radiation, immediately following activation and 24 hours after activation. The indicated color hue reflects to the perception of five different observers involved in the test.

a) Quasi-Static Tensile Shear Test

In order to determine parameters for the adhesive strength on FRE, tensile shear tests are carried out according to DIN EN 1465 (2009) at 23° C.±2° C. and 50%±5% relative humidity at a testing speed of 2 mm/min. The substrates are cleaned with isopropanol and joined afterwards. The curing achieved using UV-light, and the mechanical check is performed 24 h after activation. The results are indicated in MPa (N/mm²). The figures stated are the mean value based on five measurements including standard deviation.

c) Peel Test

The peel resistance of the cured adhesive tapes on a typical automotive paint, e.g. PPG 2K-ApO Klarlack 1.2 [A-6203512] determined according to DIN EN 1939 (1996) at 23° C.±2° C. and 50%±5% relative humidity at a testing speed of 100 mm/min and a peel-off angle of 90°. The samples are cured using UV-light and tested 24 h after activation. The results are indicated in N/mm. The figures stated are the mean value based on five tear resistance measurements including standard deviation.

d) Tensile Test

In order to determine parameters for the strength of the adhesive film alone in its cured state, tensile tests are carried out according to DIN EN 527 (2012) at 23° C.±2° C. and 50%±5% relative humidity at a testing speed of 10 mm/min. To this end, strips of a width of 19 mm and of a length of 100 mm are cut out of completely cured adhesive films. In the results illustrated, the layer thickness amounts to 0.2 mm. The samples are cured using UV light and tested 24 h after activation. The results are indicated in MPa (N/mm²). The figures stated are the mean value based on five measurements including standard deviation.

e) Expansion

Expansion after drying is carried out by measuring the layer thickness using a thickness gauge. A sample without fillers is used as reference that was produced with the same coating parameters. Measurements were taken once immediately after coating and drying of the adhesive compound as described above in the section on production of the pressure-sensitive adhesive compounds. Expansion derives from the following formula:

$$Expansion [ \% ] = \frac{100 \% \cdot Thickness of the adhesive film modified with filler agents}{Thickness of the reference without filler agents}$$

f) Compression

Compression is measured using a microscope of the type Keyence VHX-5000 with a magnification of 20×100. To this end, an adhesive film is clamped between two metal substrates, and film thickness is measured in the unloaded state. Subsequently, the clamped-in adhesive film is exposed to a load of 100 N and film thickness is measured once more. Compression derives from the following formula:

$$Compression [ \% ] = \frac{100 \% \cdot Thickness of the adhesive film subject to load [ mm ]}{Thickness of the adhesife film without load [ mm ]}$$

Samples:

Table 3 summarizes samples regarding the compositions in respect of the selection of the expandable filler agents, with the volume specifications indicating parts by weight. K1 to K3 are formulations according to the disclosure with expandable filler agents. V1 is an adhesive transfer film without added expandable filler agent:

TABLE 3

| Sample: | K1 | K2 | K3 | V1 |
|---|---|---|---|---|
| Phenoxy Resin PKHH-25-B | 40.0 | 40.0 | 40.0 | 40.0 |
| D.E.R 331 | 17.5 | 17.5 | 17.5 | 17.5 |
| D.E.R. 736 | 13.4 | 13.4 | 13.4 | 13.4 |
| Struktol Polycavit 3550 | 25.0 | 25.0 | 25.0 | 25.0 |
| Araldite DY 3601 | 4.1 | 4.1 | 4.1 | 4.1 |
| Omnicat 432 | 1.5 | 1.5 | 1.5 | 1.5 |
| Dynadylan GLYEO | 0.7 | 0.7 | 0.7 | 0.7 |
| Microsphere F-35D | 6.3 | — | — | — |
| Microsphere F-36D | — | 6.3 | — | — |
| Expancell 920 DU 40 | — | — | 6.3 | — |
| Methyl ethyl ketone | 55.2 | 55.2 | 55.2 | 55.2 |

Table 4 summarizes the results of the tensile shear, tensile and peel tests as well as the associated expansion and compression.

TABLE 4

| Sample: | K1 | K2 | K3 | V1 |
|---|---|---|---|---|
| Tensile shear | 4.1 ± 0.6 | 4.4 ± 0.7 | 6.2 ± 0.9 | 6.3 ± 1.0 |
| strength | (AF/CF) | (AF/CF) | (AF/CF) | (AF/CF) |
| [MPa] | | | | |
| Peel resistance | 1.64 ± 0.08 | 1.78 ± 0.12 | 1.24 ± 0.09 | 1.31 ± 0.06 |
| [N/mm] | (AF) | (AF) | (AF) | (AF) |
| Tensile | 1.9 ± 0.1 | 1.8 ± 0.1 | 1.7 ± 0.1 | 2.1 ± 0.5 |
| strength | | | | |
| [MPa] | | | | |
| Expansion after | 180 ± 10 | 200 ± 10 | 0 | 0 |
| drying [%] | | | | |
| Compression | approx. 30 | approx. 30 | 0 | 0 |
| not-cross- | | | | |
| linked @ 23° | | | | |
| C. [%] | | | | |

Key:
AF: Adhesion Failure;
CF: Cohesion Failure

Adhesive films K1 and K2, K3 and V1 all feature the same UV-activatable adhesive compounds. Only the expandable filler agent is varied to illustrate differences in the selection of the expandable filler agent.

The adhesive films according to K1, K2, K3 and V1 are not significantly different in terms of tensile shear strength within the range of the standard deviation. Thus it can be shown that the use of the expandable filler agent to achieve an adhesive film that is compressible prior to curing has no negative effect on these mechanical parameters. Also the tensile shear strength of the adhesive films according to K3 and V1 remains within the range of the standard deviation without significant differences. Here, the tensile shear strength values of the formulations K1 and K2 are slightly decreased, which is caused by the expansion.

Adhesive films K1 and K2 exhibit higher peel resistance than the films K3 and V1, which is due to the positive peel properties of the compressible adhesive film.

Expansion following drying at 90° C. for 10 minutes differs significantly for each different filler agent used. Adhesive compounds K1 and K2, where similar expandable filler agents were used, exhibit expansion of ca. 180% and 200%, respectively, whereas adhesive film K3, just like the reference without filler agent, exhibits no expansion, which in K3 is due to the different properties of the expandable filler agent employed in comparison to K1 and K2.

Due to the testing method used, compression could not be measured exactly. It very much depends on the filler agent concentration, the adhesive film thickness and previous expansion. For adhesive films K1 to K2 compression after pre-cross-linking at 90° C. for 10 minutes amounted to ca. 30%. Due to the different type of expansive filler agent or the absence of such filler agent, adhesive compounds K3 and R1 are not compressible.

As far as applicable, all individual features shown in the sample embodiments can be combined to and/or exchanged without leaving the scope of the invention.

1. An adhesive film that can be wound and punched, comprising an epoxy-based adhesive compound that can be activated by UV-radiation and/or thermally, wherein the adhesive compound comprises an admixed dye or an admixed pigment to produce a first color change after activation of the adhesive compound and a second color change after curing of the adhesive compound, and an expandable filler admixed to the adhesive compound to produce an adhesive film that is compressible when not yet cured.

2. The adhesive film that can be wound and punched of claim 1, wherein the adhesive compound further comprises:
a. 2-50 percent by weight of film former,
b. 10-70 percent by weight of aromatic epoxy resins,
c. 0.5 to 7 percent by weight of a cationic initiator,
d. 0.001-0.2 percent by weight of dye or pigment,
e. cyclo-aliphatic epoxy resins, the cyclo-aliphatic epoxy resins not exceeding 35 percent by weight
f. 0.1 to 70 percent by weight of at least one filler agent responsible for the expansion during drying
g. 0-50 percent by weight of epoxy-enhanced polyether compounds, and
h. 0-20 percent by weight of polyol,
the shares adding up to 100 percent.

3. The adhesive film that can be wound and punched of claim 1, wherein the expansive filler agent exhibits an activation temperature between 30° C. and 150° C. and reaches a maximum degree of expansion between 40° C. and 150° C.

4. The adhesive film that can be wound and punched of claim 1, wherein the not yet cured adhesive film exhibits compression between 5 and 80% depending on filler agent concentration and expansion.

5. The adhesive film that can be wound and punched of claim 1, wherein the adhesive film is a UV-activatable transfer adhesive tape without backing.

6. The adhesive film that can be wound and punched of claim 1, wherein the adhesive film comprises a UV-transparent or UV-intransparent backing.

7. The adhesive film that can be wound and punched of claim 1, wherein the adhesive film comprises at least one UV-activatable or thermally activatable adhesive compound.

8. The adhesive film that can be wound and punched of claim 1, wherein 0.001 to 0.2 percent by weight of the dye or the pigment, respectively, are admixed to the adhesive compound.

9. The adhesive film that can be wound and punched of claim 8, wherein the dye or the pigment is an azo dye or an azo pigment.

10. The adhesive film that can be wound and punched claim 9, wherein the azo dye or the azo pigment belong to the azo substances that exhibit a color change subject to the effect of acid.

11. The adhesive film that can be wound and punched of claim 2, wherein the expansive filler agent exhibits an activation temperature between 30° C. and 150° C. and reaches a maximum degree of expansion between 40° C. and 150° C.

12. The adhesive film that can be wound and punched of claim 11, wherein the not yet cured adhesive film exhibits compression between 5 and 80% depending on filler agent concentration and expansion

13. The adhesive film that can be wound and punched of claim 11, wherein the expansive filler agent reaches a maximum degree of expansion between 60° C. and 130° C.

14. The adhesive film that can be wound and punched of claim 2, wherein the adhesive film is a UV-activatable transfer adhesive tape without backing.

15. The adhesive film that can be wound and punched of claim 14, wherein the adhesive film comprises at least one UV-activatable or thermally activatable adhesive compound.

16. The adhesive film that can be wound and punched of claim 2, wherein the adhesive film comprises a UV-transparent or UV-intransparent backing.

17. The adhesive film that can be wound and punched of claim 16, wherein the adhesive film comprises at least one UV-activatable or thermally activatable adhesive compound.

18. The adhesive film that can be wound and punched of claim 3, wherein the expansive filler agent reaches a maximum degree of expansion between 60° C. and 130° C.

19. The adhesive film that can be wound and punched of claim 8, wherein 0.01 to 0.07 percent by weight the dye or the pigment, respectively, are admixed to the adhesive compound.

20. The adhesive film that can be wound and punched of claim 19, wherein 0.015 to 0.04 percent by weight, respectively, of the dye or the pigment are admixed to the adhesive compound
